(19) United States
(12) Patent Application Publication
(10) Pub. No.: US 2024/0243276 A1
(43) Pub. Date: Jul. 18, 2024

(54) LITHIUM NICKEL-BASED COMPOSITE OXIDE AS A POSITIVE ELECTRODE ACTIVE MATERIAL FOR RECHARGEABLE LITHIUM-ION BATTERIES

(71) Applicant: UMICORE, Brussels (BE)

(72) Inventors: Bin-Na YUN, Chungcheongnam-do (KR); KyungSub JUNG, Chungcheongnam-do (KR); Ji-Yeong KWON, Chungcheongnam-do (KR); Woon-Hyoung RYU, Chungcheongnam-do (KR); SeungHwan LEE, Chungcheongnam-do (KR); Maxime BLANGERO, Chungcheongnam-do (KR)

(21) Appl. No.: 18/562,316

(22) PCT Filed: May 27, 2022
(86) PCT No.: PCT/EP2022/064464

§ 371 Date: Nov. 19, 2023

Related U.S. Application Data
(60) Provisional application No. 63/193,752, filed on May 27, 2021.

(30) Foreign Application Priority Data
Oct. 26, 2021 (EP) 21204671.8
Oct. 26, 2021 (EP) 21204689.0

(51) Int. Cl. H01M 4/525; H01M 4/02; H01M 4/62; H01M 10/0525

(52) U.S. Cl. CPC H01M 4/525; H01M 2004/028; H01M 4/623; H01M 10/0525

(57) ABSTRACT

The present invention provides a positive electrode active material for lithium-ion rechargeable batteries, wherein the positive electrode active material comprises Li, M′, and oxygen, wherein M′ comprises: —Ni in a content x between 60.0 mol % and 95.0 mol %, relative to M′; —Co in a content y, wherein 0)<y<40.0 mol %, relative to M′: —Mn in a content z, wherein 0)<z<70.0 mol %, relative to M′: -D in a content a, wherein 0<a<2.0 mol %, relative to M′, wherein D comprises an element other than Li, O, Ni, Co, Mn, F, W and B; —F in a content b, wherein b>0, preferably between 0.1 mol % and 4.0 mol %, relative to M′; —W in a content c between 0.1 mol % and 4.0 mol %, relative to M′; —B in a content e, wherein 0<e<4.0 mol %, relative to M′; and, -wherein x, y, z, a, e and c are measured by Inductively Coupled Plasma—Optical Emission Spectrometry (ICP-OES), -wherein b is measured by Ion chromatography (IC), -wherein x++y+z+a+b+c+e is 100.0 mol %, wherein the positive electrode active material has a F content FA defined as formula (I) and W content WA defined as formula (II), wherein the positive electrode active material has a F content F_{B} and a W content W_{B} wherein F_{B} and W_{B} are determined by XPS analysis, wherein F_{B} and W_{B} are each expressed as molar fraction compared to the sum of molar fractions of Co, Mn, Ni, F, W, and B, as measured by X-ray photoelectron spectroscopy, wherein the ratio F_{B}/F_{A}>1.0, wherein the ratio W_{B}/W_{A}>1.0.

### TECHNICAL FIELD AND BACKGROUND

The present invention relates to a lithium nickel-based oxide positive electrode active material for lithium-ion secondary batteries (LIBs) suitable for electric vehicle (EV) and hybrid electric vehicle (HEV) applications, comprising lithium transition metal-based oxide particles comprising fluorine.

A positive electrode active material is defined as a material which is electrochemically active in a positive electrode. By active material, it must be understood a material capable to capture and release Li ions when subjected to a voltage change over a predetermined period of time.

It is therefore an object of the present invention to provide a positive electrode active material having one or more improved properties, such as reduced carbon content and increased cycle life as indicated by the capacity fading rate (QF) value in an electrochemical cell

### ACKNOWLEDGMENT

This invention was made with the support from Materials/Parts Technology Development Program through Korea evaluation institute of industrial technology funded by Ministry of Trade, Industry and Energy (MOTIE, Republic of Korea). [Project Name: Development of high power (high discharge rate) lithium-ion secondary batteries with 8C-rate class/Project Number: 20011287/Contribution rate: 100%]

### SUMMARY OF THE INVENTION

This objective is achieved by providing a positive electrode active material for lithium-ion batteries, wherein the positive electrode active material comprises Li, M′, and oxygen, wherein M′ comprises:
Ni in a content x between 60.0 mol % and 95.0 mol %, preferably in a content x between 80.0 mol % and 95 mol % relative to M′;
Co in a content y, wherein 0≤y≤40.0 mol %, relative to M′;
Mn in a content z, wherein 0≤z≤70.0 mol %, relative to M′;
D in a content a, wherein 0≤a≤2.0 mol %, relative to M′, wherein D comprises an element other than Li, O, Ni, Co, Mn, F, W and B, and preferably D comprises at least one element of the group consisting of: Al, Ba, Ca, Cr, Fe, Mg, Mo, Nb, S, Si, Sr, Ti, Y, V, Zn, and Zr;
F in a content b, wherein b>0, preferably between 0.1 mol % and 4.0 mol %, relative to M′;
W in a content c, wherein c>0, preferably between 0.1 mol % and 4.0 mol %, relative to M′;
Optionally, S in a content d, wherein 0≤d≤4.0 mol %, relative to M′;
B in a content e, wherein 0≤e≤4.0 mol %, relative to M′; and,
wherein x, y, z, a, e and c are measured by ICP-OES,
wherein b is measured by IC,
wherein x+y+z+a+b+c+d+e is 100.0 mol %,

$$\frac{b}{( x + y + z + b + c + d + e )}$$

and W content WA defined as

$$\frac{c}{( x + y + z + b + c + d + e )} ,$$

wherein the positive electrode active material has a F content F_{A} defined as
wherein the positive electrode active material has a F content F_{B} and a W content W_{B} wherein F_{B} and We are determined by XPS analysis, wherein F_{B} and W_{B} are each expressed as molar fraction compared to the sum of molar fractions of Co, Mn, Ni, F, W, S, and B, as measured by XPS analysis,
wherein the ratio F_{B}/F_{A}>1.0,
wherein the ratio W_{B}/W_{A}>1.0.

In some cases, the positive electrode active material further comprises S in a content d wherein d>0, preferably 0.01 mol %≤d≤3.0 mol %, wherein the positive electrode active material has a S content SA defined as

$$\frac{d}{( x + y + z + b + c + d + e )} ,$$

wherein the positive electrode active material has a S content S_{B} determined by XPS analysis, wherein S_{B} is expressed as molar fraction compared to the sum of molar fractions of Co, Mn, Ni, F, W, S, and B as measured by XPS analysis, wherein the ratio S_{B}/S_{A}>1.0.

The present invention concerns the following embodiments:

### Embodiment 1

In a first aspect, the present invention concerns a positive electrode active material for lithium-ion batteries, wherein the positive electrode active material comprises Li, M′, and oxygen, wherein M′ comprises:
Ni in a content x between 60.0 mol % and 95.0 mol %, relative to M′;
Co in a content y, wherein 0≤y≤40.0 mol %, relative to M′;
Mn in a content z, wherein 0≤z≤70.0 mol %, relative to M′;
D in a content a, wherein 0≤a≤2.0 mol %, relative to M′, wherein D comprises an element other than Li, O, Ni, Co, Mn, F, W and B, and preferably D comprises at least one element of the group consisting of: Al, Ba, Ca, Cr, Fe, Mg, Mo, Nb, S, Si, Sr, Ti, Y, V, Zn, and Zr;
F in a content b between 0.1 mol % and 4.0 mol %, relative to M′;
W in a content c between 0.1 mol % and 4.0 mol %, relative to M′;
Optionally, S in a content d, wherein 0≤e≤4.0 mol %, relative to M′;
B in a content e, wherein 0≤e≤4.0 mol %, relative to M′; and
wherein x, y, z, a, e, d, and c are measured by ICP-OES,
wherein b is measured by IC,
wherein x+y+z+a+b+c+d+e is 100.0 mol %,
   wherein the positive electrode active material has a F content F_{A} defined as

$$\frac{b}{( x + y + z + b + c + d + e )}$$

and W content W_{A} defined as

$$\frac{c}{( x + y + z + b + c + d + e )} ,$$

wherein the positive electrode active material has a F content F_{B} and a W content W_{B}
wherein F_{B} and W_{B} are determined by XPS analysis, wherein F_{B} and We are each expressed as molar fraction compared to the sum of molar fractions of Co, Mn, Ni, F, W, S, and B, as measured by XPS analysis,
wherein the ratio F_{B}/F_{A}>1.0,
wherein the ratio W_{B}/W_{A}>1.0.

Preferably, F_{B}/F_{A}>2.0, more preferably F_{B}/F_{A}>5.0, and most preferably F_{B}/F_{A}≥10.0.

Preferably, F_{B}/F_{A}<60.0 and more preferably F_{B}/F_{A}<50.0, and most preferably F_{B}/F_{A}≤ 40.0.

Preferably, W_{B}/W_{A}>2.0, more preferably W_{B}/W_{A}>5.0, and most preferably W_{B}/W_{A}≥ 30.0.

Preferably, W_{B}/W_{A}<100.0 and more preferably W_{B}/W_{A}<90.0, and most preferably W_{B}/W_{A}≤85.0.

Preferably, the Ni content x≥65.0 mol % and more preferably x≥70.0 mol %, even more preferably more than 75 mol %, relative to M′.

Preferably, the Ni content x≤93.0 mol % and more preferably x≤91.0 mol %, even more preferably less than 87 mol %, relative to M′.

Preferably, the Co content y>2.0 mol %, more preferably y≥3.0 mol % and even more preferably y≥4.0 mol %, relative to M′.

In one embodiment, the Co content y<20 mol %, more preferably y<15 mol % and even more preferably <12.5 mol %, relative to M′.

Preferably, the Mn content z>1 mol %, more preferably ≥3.0 mol % and even more preferably z≥4.0 mol %, relative to M′.

In one embodiment, the Mn content y<20 mol %, more preferably Mn<15 mol % and even more preferably <12.5 mol %, relative to M′.

Preferably, a is between 0.01 mol % and 2.0 mol %, and preferably a is between 0.1 mol % and 1.8 mol %, relative to M′.

Preferably, B is present in a content b between 0.1 mol % and 2 mol %, and even more preferably from 0.2 mol % to 1 mol %.

Preferably, F is present in a content b between 0.1 mol % and 2 mol %, and even more preferably from 0.2 mol % to 1 mol %.

Preferably, W is present in a content b between 0.1 mol % and 2 mol %, and even more preferably from 0.2 mol % to 1 mol %.

In some cases, the positive electrode active material of the invention further comprises S in a content between 0 and 4.0 mol %, preferably between 0.1 mol % and 2 mol %, and even more preferably from 0.2 mol % to 1 mol %, relative to M′.

Preferably, the positive electrode active material is in the form of a powder.

For completeness it should be noted that if in the definition of the invention a content of an element is stated using the symbols ‘0≤’ this means that the presence of said element is optional.

### Embodiment 2

In a second embodiment, preferably according to the Embodiments 1, said material comprises B in a content e, wherein e>0, probably 0.01 mol %≤e≤4.0 mol %, wherein the positive electrode active material has a B content BA defined as

$$\frac{e}{( x + y + z + b + c + d + e )} ,$$

wherein the positive electrode active material has a B content BB determined by XPS analysis, wherein B_{B} is expressed as molar fraction compared to the sum of molar fractions of Co, Mn, Ni, F, W, S, and B as measured by XPS analysis,
wherein the ratio B_{B}/B_{A}>1.0.
Preferably, B_{B}/B_{A}>2.0.
More preferably, B_{B}/B_{A}>5.0 and most preferably B_{B}/B_{A}≥20.0.
Preferably, B_{B}/B_{A}<60.0 and more preferably, B_{B}/B_{A}≤50.0.

### Embodiment 3

In a third aspect, the present invention provides a battery comprising the positive electrode active material of the present invention.

In a further aspect, the present invention provides the use of a battery according to the present invention in a portable computer, a tablet, a mobile phone, an electrically powered vehicle, or an energy storage system.

### Embodiment 4

A fourth embodiment c a positive electrode active material for lithium-ion batteries, wherein the positive electrode active material comprises Li, M′, and oxygen, wherein M′ comprises:
Ni in a content x between 60.0 mol % and 95.0 mol %, relative to M′;
Co in a content y, wherein 0≤y≤40.0 mol %, relative to M′;
Mn in a content z, wherein 0≤z≤70.0 mol %, relative to M′,
D in a content a, wherein 0≤a≤2.0 mol %, relative to M′, wherein D comprises at least one element of the group consisting of: Al, Ba, Ca, Cr, Fe, Mg, Mo, Nb, Si, Sr, Ti, Y, V, Zn, and Zr, and,
F in a content b between 0.1 mol % and 4.0 mol %, relative to M′,
W in a content c between 0.1 mol % and 4.0 mol %, relative to M′,
S in a content d, wherein 0≤d≤3.0 mol %, relative to M′,
B in a content e, wherein 0≤e≤4.0 mol %, relative to M′,
wherein x, y, z, a, d, e and c are measured by ICP-OES,
wherein b is measured by IC,
wherein x+y+z+a+b+c+d+e is 100.0 mol %,

$$\frac{b}{( x + y + z + b + c + d + e )}$$

wherein the positive electrode active material has a F content F_{A} defined as and W content W_{A} defined as

$$\frac{c}{( x + y + z + b + c + d + e )} ,$$

wherein the positive electrode active material has a F content F_{B} and a W content W_{B} wherein F_{B} and W_{B} are determined by XPS analysis, wherein F_{B} and W_{B} are each expressed as molar fraction compared to the sum of molar fractions of Co, Mn, Ni, F, W, B and S, as measured by XPS analysis,
wherein the ratio F_{B}/F_{A}>1.0,
wherein the ratio W_{B}/W_{A}>1.0.
Preferably, F_{B}/F_{A}>2.0.
Preferably, W_{B}/W_{A}>1.0.

For completeness it should be noted that if in the definition of the invention a content of an element is stated using the symbols ‘0 s’ this means that the presence of said element is optional.

### Embodiment 5

In a fifth embodiment, preferably according to the Embodiment 4, said material comprises S in a content d, wherein 0.01 mol %≤d≤3.0 mol %, wherein the positive electrode active material has a S content S_{A} defined as

$$\frac{d}{( x + y + z + b + c + d + e )} ,$$

wherein the positive electrode active material has a S content S_{B} determined by XPS analysis, wherein S_{B} is expressed as molar fraction compared to the sum of molar fractions of Co, Mn, Ni, F, W, S, and B as measured by XPS analysis,
wherein the ratio S_{B}/S_{A}>1.0.
Preferably, S_{B}/S_{A}>2.0.

### Embodiment 6

In a sixth embodiment, preferably according to the Embodiments 4 or 5, said material comprises B in a content e, wherein 0.01 mol %≤e≤4.0 mol %, wherein the positive electrode active material has a B content B_{A} defined as

$$\frac{e}{( x + y + z + b + c + d + e )} ,$$

wherein the positive electrode active material has a B content B_{B} determined by XPS analysis, wherein B_{B} is expressed as molar fraction compared to the sum of molar fractions of Co, Mn, Ni, F, W, S, and B as measured by XPS analysis,
wherein the ratio B_{B}/B_{A}>1.0.
Preferably, B_{B}/B_{A}>2.0.

### Embodiment 7

In a seventh embodiment, the present invention concerns a positive electrode active material comprises Li, M′, and oxygen, wherein M′ comprises:
Ni in a content x between 60.0 mol % and 95.0 mol %, relative to M′;
Co in a content y, wherein 0≤y≤40.0 mol %, relative to M′;
Mn in a content z, wherein 0≤z≤70.0 mol %, relative to M′,
D in a content a, wherein 0≤a≤2.0 mol %, relative to M′, wherein D comprises at least one element of the group consisting of: AI, B, Ba, Ca, Cr, Fe, Mg, Mo, Nb, S, Si, Sr, Ti, Y, V, Zn, and Zr, and,
F in a content b between 0.1 mol % and 4.0 mol %, relative to M′,
W in a content c between 0.0 mol % and 4.0 mol %, relative to M′,
S in a content d, between 0.01 mol % and 3.0 mol %, relative to M′,
B in a content e, wherein 0≤e≤4.0 mol %
wherein x, y, z, a, c, d, and e are measured by ICP-OES,
wherein b is measured by IC,
wherein x+y+z+a+b+c+d+e is 100.0 mol %,
   wherein the positive electrode active material has a F content F_{A} defined as

$$\frac{b}{( x + y + z + b + c + d + e )}$$

and S content S_{A} defined as

$$\frac{d}{( x + y + z + b + c + d + e )} ,$$

wherein the positive electrode active material has a F content F_{B}, wherein F_{B} is determined by XPS analysis, wherein F_{B} and S_{B} are each expressed as molar fraction compared to the sum of molar fractions of Co, Mn, Ni, F, W, B and S as measured by XPS analysis,
wherein the ratio F_{B}/F_{A}>1.0, and
wherein the ratio S_{B}/S_{A}>1.0.
Preferably, F_{B}/F_{A}>2.0.
Preferably, S_{B}/S_{A}>2.0.

### DETAILED DESCRIPTION

The positive electrode active material according to the present invention typically has one or more of the following advantages of (i) a reduced carbon content and (ii) an increased cycle life. This is believed to be achieved by the positive electrode material comprising fluorine and tungsten and optionally boron.

Typically, the positive electrode material of the present invention comprises secondary particle having a median size D50 of at least 2 μm, and preferably of at least 3 μm as determined by laser diffraction particle size analysis.

Preferably, said material has a secondary particle median size D50 of at most 16 μm, and preferably of at most 15 μm as determined by laser diffraction particle size analysis.

It is clear that further product embodiments according to the invention may be provided by combining features that are covered by the different product embodiments described herein above.

In a further aspect of the present invention, the positive electrode material of the present invention may be prepared by a method comprising the steps of:
Step 1) mixing a lithium transition metal oxide with a F containing compound and a W containing compound, to obtain a mixture; and
Step 2) heating the mixture in an oxidizing atmosphere at a temperature between 250° C. and less than 500° C. so as to obtain the positive electrode active material.

Preferably, the F containing compound used in Step 1) is PVDF.

Preferably, the amount of F used in Step 1) is between 300 ppm to 3000 ppm, with respect to the weight of the lithium transition metal oxide. More preferably, the amount of F used in Step 1) is between 500 ppm to 2000 ppm, with respect to the weight of the lithium transition metal oxide.

Preferably, the W containing compound used in Step 1) is WO₃.

Preferably, the amount of W between 2000 ppm to 9000 ppm, with respect to the weight of the lithium transition metal oxide. More preferably the amount of W used in Step 1) is between 3000 ppm to 8000 ppm, with respect to the weight of the lithium transition metal oxide.

Furthermore, preferably in Step 1), a B containing compound, preferably H₃BO₃, is added together with F and W containing compound, in an amount of B between 100 ppm to 3000 ppm with respect to the weight of the lithium transition metal oxide.

Furthermore, the method comprising additional step between Step 1 and Step 2, wherein the additional step is combining mixture from Step 1) with a solution comprising a S containing compound in an amount between 500 ppm to 5000 ppm with respect to the weight of the lithium transition metal oxide.

Preferably, the S containing compound used is Al₂(SO₄)₃.

Optionally, an element other than Li, O, Ni, Co, Mn, F, W and B containing compound is added to the positive electrode material wherein preferably said element comprises at least one of the elements from a group consisting of: Al, Ba, Ca, Cr, Fe, Mg, Mo, Nb, S, Si, Sr, Ti, Y, V, Zn, and Zr. Preferably, said element containing compound is added in the mixing step together with the lithium source when preparing the transition metal oxide. Alternatively, said element containing compound may be added in the precursor preparation.

In the framework of the present invention, ppm means parts-per-million for a unit of concentration, expressing 1 ppm=0.0001 wt %.

In the following detailed description, preferred embodiments are described so as to enable the practice of the invention. Although the invention is described with reference to these specific preferred embodiments, it will be understood that the invention is not limited to these preferred embodiments. The invention includes numerous alternatives, modifications and equivalents that are apparent from consideration of the following detailed description and accompanying drawings.

### A) ICP-OES Analysis

The Li, Ni, Mn, Co, W, and B and optionally the S contents of the positive electrode active material powder are measured with the Inductively Coupled Plasma—Optical Emission Spectrometry (ICP-OES) method by using an Agillent ICP 720-OES. 2 grams of product powder sample is dissolved into 10 mL of high purity hydrochloric acid in an Erlenmeyer flask. The flask is covered by a glass and heated on a hot plate at 380° C. until complete dissolution of the precursor. After being cooled to room temperature, the solution of the Erlenmeyer flask is poured into a 250 mL volumetric flask. Afterwards, the volumetric flask is filled with deionized water up to the 250 mL mark, followed by complete homogenization. An appropriate amount of solution is taken out by pipette and transferred into a 250 ml volumetric flask for the 2^{nd} dilution, where the volumetric flask is filled with internal standard and 10% hydrochloric acid up to the 250 mL mark and then homogenized. Finally, this 50 mL solution is used for ICP-OES measurement.

### B) PSD

The particle size distribution (PSD) of the positive electrode active material powder is measured by laser diffraction particle size analysis using a Malvern Mastersizer 3000 with a Hydro MV wet dispersion accessory after having dispersed each of the powder samples in an aqueous medium. In order to improve the dispersion of the powder, sufficient ultrasonic irradiation and stirring is applied, and an appropriate surfactant is introduced. D50 is defined as the particle size at 50% of the cumulative volume % distributions obtained from the Malvern Mastersizer 3000 with Hydro MV measurements.

### C) Ion Chromatography (IC) Analysis

The amount of F in the positive electrode active material powder is measured with the Ion Chromatography (IC) method by using a Dionex ICS-2100 (Thermo scientific). 250 mL volumetric flask and 100 mL volumetric flask are rinsed with a mixed solution of 65 wt % HNO₃ and deionized water in a volumetric ratio of 1:1 right before use, then, the flasks are rinsed with deionized water at least 5 times. 2 mL of HNO₃, 2 mL of H₂O₂, and 2 mL of deionized water are mixed as a solvent. 0.5 grams of powder sample is dissolved into the mixed solvent. The solution is completely transferred from the vessel into a 250 mL volumetric flask and the flask is filled with deionized water up to 250 mL mark. The filled flask is shaken well to ensure the homogeneity of the solution. 9 mL of the solution from the 250 mL flask is transferred to a 100 mL volumetric flask. The 100 mL volumetric flask is filled with deionized water up to 100 mL mark and the diluted solution is shaken well to obtain a homogeneous sample solution. 2 mL of the sample solution is inserted into 5 mL IC vial via a syringe-OnGuard cartridge for IC measurement.

### D) Coin Cell Testing

### D1) Coin Cell Preparation

For the preparation of a positive electrode, a slurry that contains a positive electrode active material powder, conductor (Super P, Timcal), binder (KF #9305, Kureha)—with a formulation of 96.5:1.5:2.0 by weight—in a solvent (NMP, Mitsubishi) is prepared by a high-speed homogenizer. The homogenized slurry is spread on one side of an aluminum foil using a doctor blade coater with a 170 μm gap. The slurry coated foil is dried in an oven at 120° C. and then pressed using a calendaring tool. Then it is dried again in a vacuum oven to completely remove the remaining solvent in the electrode film. A coin cell is assembled in an argon-filled glovebox. A separator (Celgard 2320) is located between a positive electrode and a piece of lithium foil used as a negative electrode. 1M LiPF₆ in EC/DMC (1:2) is used as electrolyte and is dropped between separator and electrodes. Then, the coin cell is completely sealed to prevent leakage of the electrolyte.

### D2) Testing Method

The testing method is a conventional “constant cut-off voltage” test. The conventional coin cell test in the present invention follows the schedule shown in Table 2. Each cell is cycled at 25° C. using a Toscat-3100 computer-controlled galvanostatic cycling station (from Toyo). The schedule uses a 1C current definition of 220 mA/g in the 4.3 V to 3.0 V/Li metal window range. The capacity fading rate (QF) is obtained according to below equation.

$$QF ( \% / cycle ) = ( 1 - \frac{{DQ}_{34}}{{DQ}_{7}} ) \times \frac{1}{27} \times 100$$

wherein DQ1 is the discharge capacity at the first cycle, DQ7 is the discharge capacity at the 7th cycle, and DQ34 is the discharge capacity at the 34th cycle.

TABLE 1
Cycling schedule for Coin cell testing method

| | Charge | | | | Discharge | | | |
|---|---|---|---|---|---|---|---|---|
| | | | | V/Li | | | | V/Li |
| | | End | Rest | metal | | End | Rest | metal |
| Cycle | C Rate | current | (min) | (V) | C Rate | current | (min) | (V) |
| 1 | 0.1 | — | 30 | 4.3 | 0.1 | — | 30 | 3.0 |
| 2 | 0.25 | 0.05 | 10 | 4.3 | 0.20 | — | 10 | 3.0 |
| 3 | 0.25 | 0.05 | 10 | 4.3 | 0.50 | — | 10 | 3.0 |
| 4 | 0.25 | 0.05 | 10 | 4.3 | 1.00 | — | 10 | 3.0 |
| 5 | 0.25 | 0.05 | 10 | 4.3 | 2.00 | — | 10 | 3.0 |
| 6 | 0.25 | 0.05 | 10 | 4.3 | 3.00 | — | 10 | 3.0 |
| 7 | 0.25 | 0.1 | 10 | 4.3 | 0.10 | — | 10 | 3.0 |
| 8 | 0.25 | 0.1 | 10 | 4.3 | 1.00 | — | 10 | 3.0 |
| 9-33 | 0.50 | 0.1 | 10 | 4.3 | 1.00 | — | 10 | 3.0 |
| 34 | 0.25 | 0.1 | 10 | 4.3 | 0.10 | — | 10 | 3.0 |

### E) X-Ray Photoelectron Spectroscopy (XPS) Analysis

In the present invention, X-ray photoelectron spectroscopy (XPS) is used to analyze the surface of positive electrode active material powder particles. In XPS measurement, the signal is acquired from the first few nanometers (e.g. 1 nm to 10 nm) of the uppermost part of a sample, i.e. surface layer. Therefore, all elements measured by XPS are contained in the surface layer.

For the surface analysis of positive electrode active material powder particles, XPS measurement is carried out using a Thermo K-a+spectrometer (Thermo Scientific). Monochromatic Al Kα radiation (hv=1486.6 eV) is used with a spot size of 400 μm and measurement angle of 45°. A wide survey scan to identify elements present at the surface is conducted at 200 eV pass energy. C1s peak having a maximum intensity (or centered) at a binding energy of 284.8 eV is used as a calibrate peak position after data collection. Accurate narrow scans are performed afterwards at 50 eV for at least 10 scans for each identified element to determine the precise surface composition.

Curve fitting is done with CasaXPS Version2.3.19PR1.0 (Casa Software) using a Shirley-type background treatment and Scofield sensitivity factors. The fitting parameters are according to Table 2a. Line shape GL(30) is the Gaussian/Lorentzian product formula with 70% Gaussian line and 30% Lorentzian line. LA(a, β, m) is an asymmetric line-shape where α and β define tail spreading of the peak and m define the width.

TABLE 2a
XPS fitting parameter for Ni2p3, Mn2p3, Co2p3, F1s, W4f, B1s, and S2p.

| | Sensitivity | Fitting range | | |
|---|---|---|---|---|
| Element | factor | (eV) | Defined peak(s) | Line shape |
| Ni | 14.61 | 851.3 ± 0.1- | Ni2p3, Ni2p3 satellite | LA(1.33, 2.44, |
| | | 869.3 ± 0.1 | | 69) |
| Mn | 9.17 | 639.9 ± 0.1- | Mn2p3, Mn2p3 satellite | GL(30) |
| | | 649.5 ± 0.1 | | |
| Co | 12.62 | 775.8 ± 0.4- | Co2p3-1, Co2p3-2, | GL(30) |
| | | 792.5 ± 0.4 | Co2p3 satellite | |
| F | 4.43 | 682.0 ± 0.1- | F1s | LA(1.53, 243, |
| | | 688.3 ± 0.1 | | 1) |
| W | 9.80 | 32.0 ± 0.1- | W4f7, W4f5, W4f loss | GL(30) |
| | | 45.0 ± 0.1 | | |
| B | 0.49 | 187.0 ± 0.1- | B1s | GL(30) |
| | | 196.1 ± 0.1 | | |
| S | 1.677 | 162.5 ± 0.1- | S2p3, S2p1 | GL(30) |
| | | 174.2 ± 0.1 | | |

For Co and W, S peaks, constraints are set for each defined peak according to Table 2b.
W5p3 is not quantified.

TABLE 2b
XPS fitting constraints

| | | Fitting range | FWHM | |
|---|---|---|---|---|
| Element | Defined peak | (eV) | (eV) | Area |
| Co | Co2p3-1 | 776.0-780.9 | 0.5-4.0 | No constraint set |
| | Co2p3-2 | 781.0-785.0 | 0.5-4.0 | No constraint set |
| | Co2p3 satellite | 785.0-790.0 | 0.5-6.0 | No constraint set |
| W | W4f7 | 33.0-36.0 | 0.2-4.0 | No constraint set |
| | W4f5 | 36.1-39.0 | Same as | 75% of W4f7 area |
| | | | W4f7 | |
| | W5p3 | 39.1-43.0 | 0.5-2.5 | No constraint set |
| S | S2p3 peak | 167.0-170.0 | 0.2-4.0 | No constraint set |
| | S2p1 peak | 170.0-172.0 | Same as | 50% of S2p3 area |
| | | | S2p3 | |

The F, W, S, and B surface contents as determined by XPS are expressed as a molar fraction of F, W, S, and B in the surface of the particles divided by the total content of Ni, Mn, Co, F, W, B and S in said surface. They are calculated as follows:

$$fraction of F = {F}_{B} = \frac{F ( mol \% )}{\begin{matrix}Ni ( mol \% ) + Mn ( mol \% ) + Co ( mol \% ) + \\ F ( mol \% ) + W ( mol \% ) + B ( mol \% ) + S ( mol \% )\end{matrix}}$$

$$fraction of W = {W}_{B} = \frac{W ( mol \% )}{\begin{matrix}Ni ( mol \% ) + Mn ( mol \% ) + Co ( mol \% ) + \\ F ( mol \% ) + W ( mol \% ) + B ( mol \% ) + S ( mol \% )\end{matrix}}$$

$$fraction of B = {B}_{B} = \frac{B ( mol \% )}{\begin{matrix}Ni ( mol \% ) + Mn ( mol \% ) + Co ( mol \% ) + \\ F ( mol \% ) + W ( mol \% ) + B ( mol \% ) + S ( mol \% )\end{matrix}}$$

$$fraction of S = {S}_{B} = \frac{S ( mol \% )}{\begin{matrix}Ni ( mol \% ) + Mn ( mol \% ) + Co ( mol \% ) + \\ F ( mol \% ) + W ( mol \% ) + B ( mol \% ) + S ( mol \% )\end{matrix}}$$

### F) Carbon Analyzer

The content of carbon of the positive electrode active material powder is measured by Horiba Emia-Expert carbon/sulfur analyzer. 1 gram of positive electrode active material powder is placed in a ceramic crucible in a high frequency induction furnace. 1.5 gram of tungsten and 0.3 gram of tin as accelerators are added into the crucible. The powder is heated at a programmable temperature wherein gases produced during the combustion are then analyzed by Infrared detectors. The analysis of CO₂ and CO determines carbon concentration.

The invention is further illustrated by the following (non-limitative) examples:

### Comparative Example 1

CEX1 was obtained through a solid-state reaction between a lithium source and a transition metal-based source precursor running as follows:
1) Co-precipitation: a transition metal-based oxidized hydroxide precursor was prepared using co-precipitation process in a batch reactor. Mixed nickel manganese cobalt sulfates, sodium hydroxide, and ammonia are fed into the reactor with a controlled condition. The concentration of metal salt is varied during precipitation so as to form a concentration gradient of Ni and Mn from the center to the edge of particle. The total metal composition was Ni_{0.85}Mn_{0.10}Co_{0.05}, as determined by ICP-OES.
2) Blending: the precursor prepared in step 1) and LiOH as a lithium source were homogenously blended at a lithium to metal M′ (Li/M′) ratio of 1.005 in an industrial blending equipment.
3) First heating: the blend from Step 2) was sintered at 765° C. for 10 hours under an oxygen atmosphere. The product was crushed, classified, and sieved. CEX1 had a D50 of 10.5 μm, as determined by the PSD method B above. The positive electrode active material CEX1 was determined by the CS-EDS method F above to have a concentration gradient of Ni and Mn from edge to core of particle wherein the ratio of Ni_{edge}/Ni_{center}=0.91 and ratio Mn_{edge}/Mn_{center}=2.33.

### Example 1

EX1 was prepared by mixing CEX1 with PVDF powder and WO₃ powder, respectively in the amount of 1300 ppm F and 4500 ppm W, followed by heating at 385° C. EX1 had a D50 of 10.5 μm, as determined by the PSD method B above.

### Example 2

EX2 was prepared by mixing CEX1 with H₃BO₃, PVDF powder, and WO₃ powder, respectively in the amount of 500 ppm B, 1300 ppm F, and 4500 ppm W, followed by heating at 385° C. EX2 had a D50 of 10.5 μm, as determined by the PSD method B above.

The step of using PVDF, WO₃, in the preparation of EX1; and, PVDF, WO₃ and H₃BO₃ in the preparation of EX2; lead to F_{B}/F_{A}>1.0, W_{B}/W_{A}>1.0, and B_{B}/B_{A}>1.0, respectively, wherein F_{B}, W_{B}, and B_{B} are obtained by XPS measurement and F_{A}, W_{A}, and B_{A} obtained by ICP-OES measurement.

TABLE 3
Summary of the composition and the electrochemical
properties of CEX1, EX1, and EX2.

| | | | | | | | | | | Electrochemical |
|---|---|---|---|---|---|---|---|---|---|---|
| | | | | | | | | | | properties |
| | | | | | | | | | | QF |
| | ICP-OES or IC (mol %*) | | | | S_{B}/ | B_{B}/ | F_{B}/ | W_{B}/ | Carbon | (%/100 |
| ID | S_{A} | B_{A} | F_{A} | W_{A} | S_{A} | B_{A} | F_{A} | W_{A} | (ppm) | cycles) |
| CEX1 | 0.91 | 0.00 | 0.00 | 0.00 | 24.9 | N/A | N/A | N/A | 206 | 7.38 |
| EX1 | 0.95 | 0.00 | 0.67 | 0.24 | 13.6 | N/A | 24.9 | 77.3 | 205 | 6.30 |
| EX2 | 0.94 | 0.43 | 0.68 | 0.23 | 24.2 | 34.1 | 21.6 | 51.5 | 111 | 4.16 |

*Relative to molar contents of Ni, Mn, Co, F, W, and B

For the examples shown in Table 4 above, S_{B}, F_{B}, B_{B}, and W_{B} higher than 0 indicates said elements are presence in the surface of the positive electrode active material as associated with the XPS measurement which signal is acquired from the first few nanometers (e.g. 1 nm to 10 nm) of the uppermost part of a sample, i.e. surface layer. On the other hand, F_{A}, B_{A}, and W_{A} atomic ratio obtained from ICP-OES measurement is from the entire particles. The ratio of XPS to ICP-OES of F_{B}/F_{A}, B_{B}/B_{A}, and W_{B}/W_{A} higher than 1 indicates F, B, and W elements presence mostly on the surface of the positive electrode active material.

Table 4 above shows that the positive electrode active materials EX1 and EX2 comprising F, W, and optionally B, respectively, according to the present invention, have improved properties of a lower carbon content and lower QF when used in an electrochemical cell over those of the comparative example CEX1.

### Comparative Example 3.1

CEX3.1 was obtained through a solid-state reaction between a lithium source and a transition metal-based source precursor running as follows:
1) Co-precipitation: a transition metal-based oxidized hydroxide precursor with metal composition of Ni_{0.80}Mn_{0.10}Co_{0.10} was prepared by a co-precipitation process in a large-scale continuous stirred tank reactor (CSTR) with mixed nickel-manganese-cobalt sulfates, sodium hydroxide, and ammonia.
2) Blending: the precursor prepared in step 1) and LiOH as a lithium source were homogenously blended at a lithium to metal M′ (Li/M′) ratio of 1.00 in an industrial blending equipment.
3) First heating: the blend from Step 2) was sintered at 805° C. for 12 hours under an oxygen atmosphere. The product was crushed, classified, and sieved so as to obtain a first heated powder.
4) Wet mixing: The first heated powder from step 3) was mixed with aluminum sulfate solution, which was prepared by dissolving around 3800 ppm Al₂(SO₄)₃ powder into 3.5 wt. % of deionized water with respect to the weight of the first heated powder.
5) Second heating: The mixture obtained from Step 4) was heated at 385° C. for 8 hours under an oxygen atmosphere followed by grinding and sieving so as to obtain CEX3.1 having D50 of around 13 μm.

### Comparative Example 3.2

CEX3.2 was prepared according to the same method as CEX3.1 except that a dry mixing step was added before step 4) wet mixing step. In the dry mixing step, 4000 ppm W from WO₃ powder was mixed with the first heated powder.

### Example 3.1

EX3.1 was prepared according to the same method as CEX3.1 except that a dry mixing step was added before step 4) wet mixing step. In the dry mixing step, 650 ppm F from PVDF powder and 4000 ppm W from WO₃ powder were mixed with the first heated powder.

### Example 3.2

EX3.2 was prepared according to the same method as CEX3.1 except that a dry mixing step was added before step 4) wet mixing step. In the dry mixing step, 650 ppm F from PVDF powder and 6000 ppm W from WO₃ powder were mixed with the first heated powder.

### Example 3.3

EX3.3 was prepared according to the same method as CEX3.1 except that a dry mixing step was added before step 4) wet mixing step. In the dry mixing step, 980 ppm F from PVDF powder and 4000 ppm W from WO₃ powder were mixed with the first heated powder.

The step of PVDF, WO₃, and Al₂(SO₄)₃ compounds mixing followed by heat treatment in EX3.1, EX3.2, and EX3.3 lead to F_{B}/F_{A}>1.0, W_{B}/W_{A}>1.0, and S_{B}/S_{A}>1.0, respectively, wherein F_{B}, W_{B}, and S_{B} are obtained by XPS measurement and F_{A}, W_{A}, and S_{A} obtained by ICP-OES measurement.

TABLE 4
Summary of the composition and electrochemical properties
of CEX3.1, CEX3.2, EX3.1, EX3.2, and EX3.3

| | | | | | | | | Electrochemical | |
|---|---|---|---|---|---|---|---|---|---|
| | | | | | | | | properties | |
| | | | | | | | | | QF |
| | ICP-OES or IC (mol %*) | | | S_{B}/ | F_{B}/ | W_{B}/ | Carbon | DQ1 | (%/100 |
| ID | S_{A} | F_{A} | W_{A} | S_{A} | F_{A} | W_{A} | (ppm) | (mAh/g) | cycles) |
| CEX3.1 | 0.63 | 0.00 | 0.00 | 94.7 | N/A | N/A | 241 | 207.1 | 9.9 |
| CEX3.2 | 0.60 | 0.00 | 0.22 | 89.1 | N/A | 68.2 | 67 | 209.4 | 12.5 |
| EX3.1 | 0.60 | 0.33 | 0.23 | 63.3 | 37.8 | 87.9 | 36 | 210.5 | 10.1 |
| EX3.2 | 0.62 | 0.33 | 0.37 | 60.7 | 32.5 | 61.8 | 29 | 209.5 | 10.8 |
| EX3.3 | 0.60 | 0.50 | 0.26 | 42.2 | 48.0 | 86.6 | 21 | 211.6 | 10.0 |

*Relative to molar contents of Ni, Mn, Co, F, W, B, and S

In all examples, F_{B}, S_{B}, B_{B}, and W_{B} higher than 0 indicates said elements are presence in the surface of the positive electrode active material as associated with the XPS measurement which signal is acquired from the first few nanometers (e.g. 1 nm to 10 nm) of the uppermost part of a sample, i.e. surface layer. On the other hand, F_{A}, S_{A}, B_{A}, and W_{A} atomic ratio obtained from ICP-OES measurement is from the entire particles. The ratio of XPS to ICP-OES of F_{B}/F_{A}, S_{B}/S_{A}, B_{B}/B_{A}, and W_{B}/W_{A} higher than 1 indicates F, S, B, and W elements presence mostly on the surface of the positive electrode active material.

1-17. (canceled)

18. A positive electrode active material for lithium-ion rechargeable batteries, wherein the positive electrode active material comprises Li, M′, and oxygen, wherein M′ comprises:
Ni in a content x between 60.0 mol % and 95.0 mol %, relative to M′;
Co in a content y, wherein 0≤y≤40.0 mol %, relative to M′;
Mn in a content z, wherein 0≤z≤70.0 mol %, relative to M′;
D in a content a, wherein 0≤a≤2.0 mol %, relative to M′, wherein D comprises an element other than Li, O, Ni, Co, Mn, F, W and B;
F in a content b, wherein b>0, relative to M′;
W in a content c, wherein c>0, relative to M′;
S in a content d, wherein 0≤d≤4.0 mol %, relative to M′;
B in a content e, wherein 0≤e≤4.0 mol %, relative to M′; and,
wherein x, y, z, a, e and c are measured by Inductively Coupled Plasma—Optical Emission Spectrometry (ICP-OES),
wherein b is measured by Ion Chromatography (IC),
wherein x+y+z+a+b+c+d+e is 100.0 mol %,
wherein the positive electrode active material has a F content F_{A} defined as b/(x+y+z+b+c+d+e) and W content W_{A} defined as c/(x+y+z+b+c+d+e),
wherein the positive electrode active material has a F content F_{B} and a W content W_{B}, wherein F_{B} and W_{B} are determined by X-ray photoelectron spectroscopy analysis, wherein F_{B} and W_{B} are each expressed as molar fraction compared to the sum of molar fractions of Co, Mn, Ni, F, W, S, and B, as measured by XPS analysis,
wherein the ratio F_{B}/F_{A}>1.0, and
wherein the ratio W_{B}/W_{A}>1.0.

19. The positive electrode active material according to claim 18, wherein the positive electrode active material further comprises S in a content d, wherein d>0, wherein the positive electrode active material has a S content S_{A} defined as d/(x+y+z+b+c+d+e), wherein the positive electrode active material has a S content S_{B} determined by XPS analysis, wherein S_{B} is expressed as molar fraction compared to the sum of molar fractions of Co, Mn, Ni, F, W, S, and B as measured by XPS analysis,
wherein the ratio S_{B}/S_{A}>1.0.

20. The positive electrode active material according to claim 18, wherein e>0, wherein the positive electrode active material has a B content B_{A} defined as e/(x+y+z+b+c+d+e)′
wherein the positive electrode active material has a B content B_{B} determined by XPS analysis,
wherein B_{B} is expressed as molar fraction compared to the sum of molar fractions of Co, Mn, Ni, F, W, S, and B as measured by XPS analysis,
wherein the ratio B_{B}/B_{A}>1.0.

21. The positive electrode active material according to claim 20, wherein the ratio B_{B}/B_{A}>2.0.

22. The positive electrode active material according to claim 18, wherein the ratio F_{B}/F_{A}>2.0.

23. The positive electrode active material according to claim 18, wherein the ratio W_{B}/W_{A}>2.0.

24. The positive electrode active material according to claim 18, wherein D comprises at least one element selected from the group consisting of: Al, Ba, Ca, Cr, Fe, Mg, Mo, Nb, Si, Sr, Ti, Y, V, Zn, and Zr.

25. The positive electrode active material according to claim 18, wherein D has a content a between 0.01 mol % and 2.0 mol %, relative to M′.

26. Method for manufacturing positive electrode active material according to claim 18, wherein the method comprises the following consecutive steps:
Step 1) mixing a lithium transition metal oxide with a F containing compound and a W containing compound, to obtain a mixture; and
Step 2) heating the mixture in an oxidizing atmosphere at a temperature between 250° C. and less than 500° C. so as to obtain the positive electrode active material.

27. Method according to claim 26, wherein the F containing compound is PVDF.

28. Method according to claim 26, wherein the W containing compound is WO₃.

29. Method according to claim 26, wherein in Step 1) a B containing compound is added together with F and W containing compound.

30. Method according to claim 29, wherein the B containing compound is H₃BO₃.

31. Method according to claim 26, further comprising an additional step between Step 1 and Step 2, wherein the additional step is combining mixture from Step 1) with a solution comprising an S containing compound.

32. Method according to claim 31, wherein the S containing compound is Al₂(SO₄)₃.

33. A battery comprising the positive electrode active material according to claim 18.

34. A portable computer, a tablet, a mobile phone, an electrically powered vehicle, or an energy storage system comprising a battery according to claim 33.
